(19) United States
(12) Patent Application Publication
(10) Pub. No.: US 2015/0319643 A1
(43) Pub. Date: Nov. 5, 2015

(54) UE TRANSMITTER SHARING

(71) Applicant: QUALCOMM INCORPORATED, San Diego, CA (US)

(72) Inventors: Xipeng ZHU, Beijing (CN); Neng WANG, Beijing (CN); Peng CHENG, Beijing (CN); Jilei HOU, Beijing (CN); Chao WEI, Beijing (CN); PRANAV DAYAL, San Diego, CA (US); Masato KITAZOE, Tokyo (JP)

(21) Appl. No.: 14/165,186

(22) PCT Filed: Jan. 28, 2013
(86) PCT No.: PCT/CN2013/071027

§ 371 Date: Jan. 27, 2014

(51) Int. Cl. H04W 28/04; H04W 72/04; H04W 72/12; H04B 1/04

(52) U.S. Cl. CPC H04W 28/044; H04B 1/04; H04W 72/0446; H04W 72/1284

(57) ABSTRACT

Aspects of the present disclosure relate techniques for transmitter sharing by a user equipment (UE) for simultaneous communications between multiple radio access technology (RAT) networks. Certain aspects of the present disclosure provide a method for wireless communications by a UE. The method generally includes sharing a single transmit chain via time divisional multiplexing (TDM) for concurrent communication by at least first and second RAT, optionally negotiating an autonomous denial rate for the UE to deny uplink transmissions in the second RAT, detecting or predicting conflicts between scheduled uplink transmissions in the first RAT and a scheduled transmission in the second RAT, and denying uplink transmissions in the second RAT, subject to the negotiated autonomous denial rate if available, in response to detected or predicted.

### CLAIM OF PRIORITY UNDER 35 U.S.C. §119

This application claims benefit of International PCT Application Serial No. PCT/CN2013/071027, filed Jan. 28, 2013, which is herein incorporated by reference in its entirety.

### BACKGROUND

1. Field

Aspects of the present disclosure relate generally to wireless communications, and more particularly, to techniques for transmitter sharing by a user equipment (UE) for simultaneous communications between multiple radio access technology (RAT) networks.

2. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include code division multiple access (CDMA) networks, time division multiple access (TDMA) networks, frequency division multiple access (FDMA) networks, orthogonal FDMA (OFDMA) networks, and single-carrier FDMA (SC-FDMA) networks.

A user equipment (UE) may be located within the coverage of multiple wireless networks, which may support different communication services. A suitable wireless network may be selected to serve the UE based on one or more criteria. The selected wireless network may be unable to provide a desired communication service (e.g., voice service) for the UE. A set of procedures may then be performed to redirect the UE to another wireless network (e.g., 2G, 3G or non-LTE 4G) that can provide the desired communication service.

### SUMMARY

Aspects of the present disclosure provide techniques for transmitter sharing by a user equipment (UE) for simultaneous communications between multiple radio access technology (RAT) networks.

Certain aspects of the present disclosure provide a method for wireless communications by a user equipment (UE). The method generally includes sharing a single transmit chain via time-division multiplexing (TDM) for concurrent communication by at least first and second radio access technologies (RAT), optionally negotiating an autonomous denial rate for the UE to deny uplink transmissions in the second RAT, detecting or predicting conflicts between uplink transmissions in the first RAT and a transmission in the second RAT, and denying uplink transmissions in the second RAT, subject to the negotiated autonomous denial rate if available, in response to detected or predicted conflicts.

Certain aspects of the present disclosure provide a method for wireless communications by a base station. The method generally includes negotiating an autonomous denial rate for a user equipment (UE) to deny uplink transmissions to the base station and communicating with the UE, wherein the UE is allowed to deny uplink transmissions to the base station, subject to the negotiated autonomous denial rate.

Certain aspects of the present disclosure provide a method for wireless communications by a user equipment (UE). The method generally includes sharing a single transmit chain via time-division multiplexing (TDM) for concurrent communication by at least first and second radio access technologies (RAT) and providing assistance information to a base station of the second RAT to assist the base station in avoiding scheduling uplink transmissions that conflict with uplink transmission in the first RAT.

Certain aspects of the present disclosure provide a method for wireless communications by a base station. The method generally includes receiving assistance information from a user equipment (UE) indicating when uplink transmissions from the UE in a first radio access technology (RAT) conflict with uplink transmissions from the UE in a second RAT and avoiding scheduling at least some uplink transmissions based on the assistance information.

Certain aspects of the present disclosure provide a method for wireless communications by a base station. The method generally includes gathering information regarding potential conflicts between uplink transmissions from a UE in a first radio access technology (RAT) with uplink transmissions from the UE in a second RAT and avoiding scheduling at least some uplink transmissions from the UE in the second RAT, based on the gathered information.

Certain aspects of the present disclosure provide a method for wireless communications by a user equipment (UE). The method generally includes sharing a single transmit chain via time-division multiplexing (TDM) for concurrent communication by at least first and second radio access technologies (RAT), detecting or predicting conflicts between scheduled uplink transmissions in the first RAT related to a voice call and a scheduled transmission in the second RAT and denying uplink transmissions in the second RAT in response to detected or predicted conflicts, subject to maintaining a level of voice quality for the voice call.

Certain aspects of the present disclosure provide an apparatus for wireless communications by a user equipment (UE). The apparatus generally includes means for sharing a single transmit chain via time-division multiplexing (TDM) for concurrent communication by at least the first and second radio access technologies (RAT), means for negotiating an autonomous denial rate for the UE to deny uplink transmissions in the second RAT, means for detecting or predicting conflicts between uplink transmissions in the first RAT and a transmission in the second RAT and means for denying uplink transmissions in the second RAT, subject to the negotiated autonomous denial rate, in response to detected or predicted conflicts.

Certain aspects of the present disclosure provide for an apparatus for wireless communications by a user equipment (UE). The apparatus generally includes at least one processor configured to share a single transmit chain via time-division multiplexing (TDM) for concurrent communication by at least first and second radio access technologies (RAT), negotiate an autonomous denial rate for the UE to deny uplink transmissions in the second RAT, detect or predict conflicts between uplink transmissions in the first RAT and a transmission in the second RAT and deny uplink transmissions in the second RAT, subject to the negotiated autonomous denial rate, in response to detected or predicted conflicts. The apparatus also includes a memory coupled with the at least one processor.

Certain aspects of the present disclosure provide for a computer program product for wireless communications by a user equipment (UE). The computer program product generally includes a computer readable medium having instructions stored thereon, the instructions are generally executable by one or more processors for sharing a single transmit chain via time-division multiplexing (TDM) for concurrent communication by at least first and second radio access technologies (RAT), negotiating an autonomous denial rate for the UE to deny uplink transmissions in the second RAT, detecting or predicting conflicts between uplink transmissions in the first RAT and a transmission in the second RAT, and denying uplink transmissions in the second RAT, subject to the negotiated autonomous denial rate, in response to detected or predicted conflicts.

Certain aspects of the present disclosure provide for an apparatus for wireless communications by a base station. The apparatus generally includes means for negotiating an autonomous denial rate for a user equipment (UE) to deny uplink transmissions to the base station and means for communicating with the UE, wherein the UE is allowed to deny uplink transmissions to the base station, subject to the negotiated autonomous denial rate

Certain aspects of the present disclosure provide for an apparatus for wireless communications by a base station. The apparatus generally includes at least one processor configured to negotiate an autonomous denial rate for a user equipment (UE) to deny uplink transmissions to the base station and communicate with the UE, wherein the UE is allowed to deny uplink transmissions to the base station, subject to the negotiated autonomous denial rate. The apparatus also includes a memory coupled with the at least one processor.

Certain aspects of the present disclosure provide for a computer program product for wireless communications by a base station. The computer program product generally includes a computer readable medium having instructions stored thereon, the instructions executable by one or more processors for negotiating an autonomous denial rate for a user equipment (UE) to deny uplink transmissions to the base station and communicating with the UE, wherein the UE is allowed to deny uplink transmissions to the base station, subject to the negotiated autonomous denial rate

Certain aspects of the present disclosure provide for an apparatus for wireless communications by a user equipment (UE). The apparatus generally includes means for sharing a single transmit chain via time-division multiplexing (TDM) for concurrent communication by at least first and second radio access technologies (RAT) and means for providing assistance information to a base station of the second RAT to assist the base station in avoiding scheduling uplink transmissions that conflict with uplink transmission in the first RAT.

Certain aspects of the present disclosure provide for an apparatus for wireless communications by a user equipment (UE). The apparatus generally includes at least one processor configured to share a single transmit chain via time-division multiplexing (TDM) for concurrent communication by at least first and second radio access technologies (RAT) and provide assistance information to a base station of the second RAT to assist the base station in avoiding scheduling uplink transmissions that conflict with uplink transmission in the first RAT. The apparatus also includes a memory coupled with the at least one processor.

Certain aspects of the present disclosure provide for a computer program product for wireless communications by a user equipment (UE). The computer program product generally includes a computer readable medium having instructions stored thereon, the instructions executable by one or more processors for sharing a single transmit chain via time-division multiplexing (TDM) for concurrent communication by at least first and second radio access technologies (RAT) and providing assistance information to a base station of the second RAT to assist the base station in avoiding scheduling uplink transmissions that conflict with uplink transmission in the first RAT.

Certain aspects of the present disclosure provide for an apparatus for wireless communications by a base station. The apparatus generally includes means for receiving assistance information from a user equipment (UE) indicating when uplink transmissions from the UE in a first radio access technology (RAT) conflict with uplink transmissions from the UE in a second RAT and means for avoiding scheduling at least some uplink transmissions based on the assistance information.

Certain aspects of the present disclosure provide for an apparatus for wireless communications by a base station. The apparatus generally includes at least one processor configured to receive assistance information from a user equipment (UE) indicating when uplink transmissions from the UE in a first radio access technology (RAT) conflict with uplink transmissions from the UE in a second RAT and avoid scheduling at least some uplink transmissions based on the assistance information. The apparatus also includes a memory coupled with the at least one processor.

Certain aspects of the present disclosure provide for a computer program product for wireless communications by a base station. The computer program product generally includes a computer readable medium having instructions stored thereon, the instructions executable by one or more processors for receiving assistance information from a user equipment (UE) indicating when uplink transmissions from the UE in a first radio access technology (RAT) conflict with uplink transmissions from the UE in a second RAT and avoiding scheduling at least some uplink transmissions based on the assistance information.

Certain aspects of the present disclosure provide for an apparatus for wireless communications by a base station. The apparatus generally includes means for gathering information regarding potential conflicts between uplink transmissions from a UE in a first radio access technology (RAT) with uplink transmissions from the UE in a second RAT and means for avoiding scheduling at least some uplink transmissions from the UE in the second RAT, based on the gathered information.

Certain aspects of the present disclosure provide for an apparatus for wireless communications by a base station. The apparatus generally includes at least one processor configured to gather information regarding potential conflicts between uplink transmissions from a UE in a first radio access technology (RAT) with uplink transmissions from the UE in a second RAT and avoid scheduling at least some uplink transmissions from the UE in the second RAT, based on the gathered information. The apparatus also includes a memory coupled with the at least one processor.

Certain aspects of the present disclosure provide for a computer program product for wireless communications by a base station. The computer program product generally includes a computer readable medium having instructions stored thereon, the instructions executable by one or more processors for gathering information regarding potential conflicts between uplink transmissions from a UE in a first radio access technology (RAT) with uplink transmissions from the UE in a second RAT and avoiding scheduling at least some uplink transmissions from the UE in the second RAT, based on the gathered information.

Certain aspects of the present disclosure provide for an apparatus for wireless communications by a user equipment (UE). The apparatus generally includes means for sharing a single transmit chain via time-division multiplexing (TDM) for concurrent communication by at least first and second radio access technologies (RAT), means for detecting or predicting conflicts between scheduled uplink transmissions in the first RAT related to a voice call and a scheduled transmission in the second RA, and means for denying uplink transmissions in the second RAT in response to detected or predicted conflicts, subject to maintaining a level of voice quality for the voice call.

Certain aspects of the present disclosure provide for an apparatus for wireless communications by a user equipment (UE). The apparatus generally includes at least one processor configured to share a single transmit chain via time-division multiplexing (TDM) for concurrent communication by at least first and second radio access technologies (RAT), detect or predict conflicts between scheduled uplink transmissions in the first RAT related to a voice call and a scheduled transmission in the second RAT, and deny uplink transmissions in the second RAT in response to detected or predicted conflicts, subject to maintaining a level of voice quality for the voice call. The apparatus also includes a memory coupled with the at least one processor.

Certain aspects of the present disclosure provide for a computer program product for wireless communications by a user equipment (UE). The computer program product generally includes a computer readable medium having instructions stored thereon, the instructions executable by one or more processors for sharing a single transmit chain via time-division multiplexing (TDM) for concurrent communication by at least first and second radio access technologies (RAT), detecting or predicting conflicts between scheduled uplink transmissions in the first RAT related to a voice call and a scheduled transmission in the second RAT, and denying uplink transmissions in the second RAT in response to detected or predicted conflicts, subject to maintaining a level of voice quality for the voice call.

Various aspects and features of the disclosure are described in further detail below.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an exemplary deployment in which multiple wireless networks have overlapping coverage, in accordance with certain aspects of the present disclosure.

FIG. 2 illustrates a block diagram of a user equipment (UE) and other network entities, in accordance with certain aspects of the present disclosure.

FIG. 3 illustrates a Global System for Mobile Communications (GSM) radio frame and a long-term evolution (LTE) radio frame configuration for achieving simultaneous GSM/LTE (SGLTE), in accordance with certain aspects of the present disclosure.

FIG. 4 illustrates an example UE supporting multiple interfering radio access technologies (RATs), in accordance with certain aspects of the present disclosure.

FIG. 5 illustrates an example In-Device Coexistence (IDC) procedure, in accordance with certain aspects of the present disclosure.

FIG. 6 illustrates a block diagram overview of solution techniques, in accordance with certain aspects of the present disclosure

FIG. 7 illustrates example operations that may be performed by a UE, in accordance with certain aspects of the present disclosure.

FIG. 8 illustrates example operations that may be performed by a base station, in accordance with certain aspects of the present disclosure.

FIG. 9 illustrates example operations that may be performed by a UE, in accordance with certain aspects of the present disclosure.

FIG. 10 illustrates example operations that may be performed by a base station, in accordance with certain aspects of the present disclosure.

FIG. 11 illustrates example operations that may be performed by a base station, in accordance with certain aspects of the present disclosure.

FIG. 12 illustrates example operations that may be performed by a UE, in accordance with certain aspects of the present disclosure.

### DETAILED DESCRIPTION

Aspects of the present disclosure relate generally to wireless communications, and more particularly, to techniques for transmitter sharing by a user equipment (UE) for simultaneous communications between multiple radio access technology (RAT) networks.

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as code division multiple access (CDMA), time division multiple access (TDMA), frequency division multiple access (FDMA), orthogonal FDMA (OFDMA), single carrier FDMA (SC-FDMA) and other networks. The terms “network” and “system” are often used interchangeably. A CDMA network may implement a radio access technology (RAT) such as universal terrestrial radio access (UTRA), cdma2000, etc. UTRA includes wideband CDMA (WCDMA) and other variants of CDMA. cdma2000 covers IS-2000, IS-95 and IS-856 standards. IS-2000 is also referred to as 1x radio transmission technology (1xRTT), CDMA2000 1X, etc. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), IEEE 802.11 (Wi-Fi), IEEE 802.16 (WiMAX), IEEE 802.20, Flash-OFDM.®, etc. UTRA and E-UTRA are part of universal mobile telecommunication system (UMTS). 3GPP long-term evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and RATs mentioned above as well as other wireless networks and RATs.

Circuit-switched fallback (CSFB) is a technique to deliver voice-services to a mobile, when the mobile is camped in a long-term evolution (LTE) network. This may be required when the LTE network does not support voice services natively. The LTE network and a 3GPP CS network (e.g., UMTS or GSM) may be connected using a tunnel interface. The UE may register with the 3GPP CS network while on the LTE network by exchanging messages with the 3GPP CS core network over the tunnel interface.

### An Example Wireless Communications System

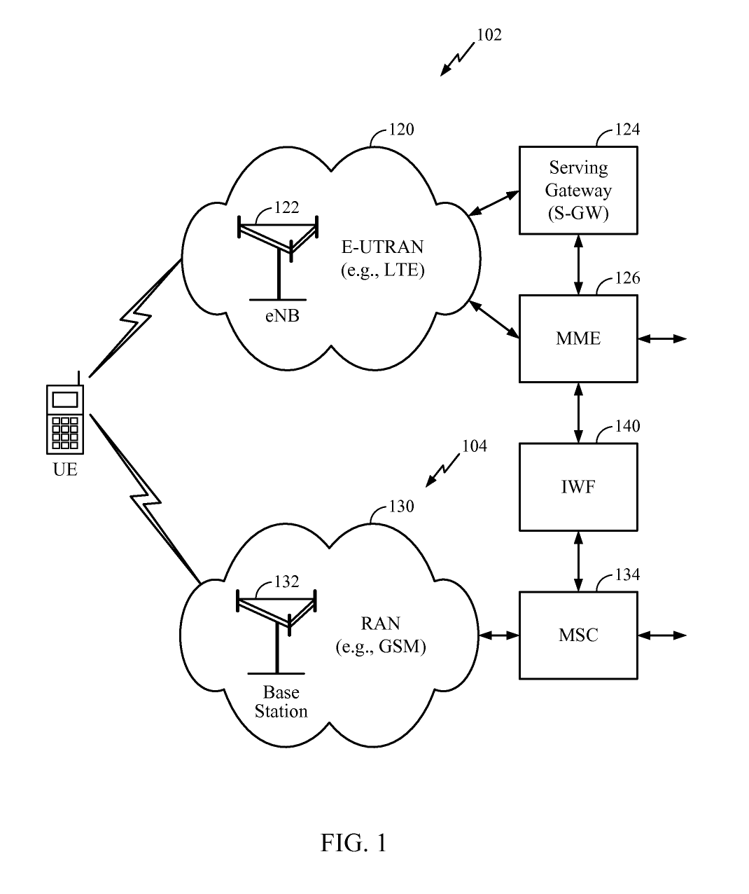

FIG. 1 shows an exemplary deployment in which multiple wireless networks have overlapping coverage. An evolved universal terrestrial radio access network (E-UTRAN) 120 may support LTE and may include a number of evolved Node Bs (eNBs) 122 and other network entities that can support wireless communication for user equipments (UEs). Each eNB may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network-triggered services, etc. A mobility management entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A radio access network (RAN) 130 may support GSM and may include a number of base stations 132 and other network entities that can support wireless communication for UEs. A mobile switching center (MSC) 134 may communicate with the RAN 130 and may support voice services, provide routing for circuit-switched calls, and perform mobility management for UEs located within the area served by MSC 134. Optionally, an inter-working function (IWF) 140 may facilitate communication between MME 126 and MSC 134 (e.g., for 1xCSFB).

E-UTRAN 120, serving gateway 124, and MME 126 may be part of an LTE network 102. RAN 130 and MSC 134 may be part of a GSM network 104. For simplicity, FIG. 1 shows only some network entities in the LTE network 102 and the GSM network 104. The LTE and GSM networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for voice-over-Internet protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1xRTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

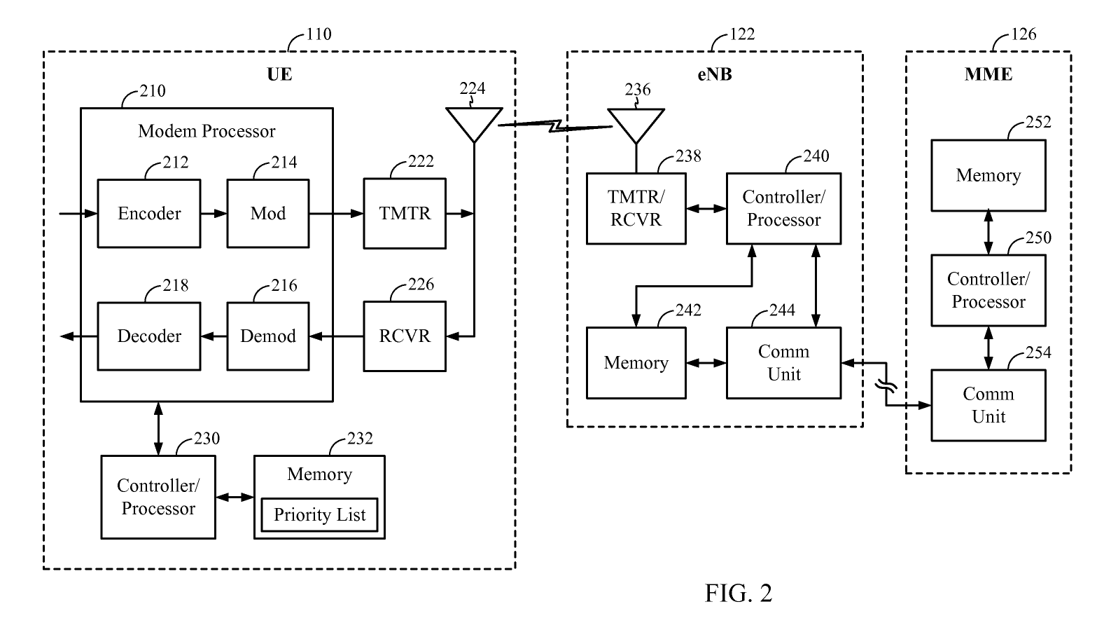

FIG. 2 shows a block diagram of a design of UE 110, eNB 122, and MME 126 in FIG. 1. At UE 110, an encoder 212 may receive traffic data and signaling messages to be sent on the uplink. Encoder 212 may process (e.g., format, encode, and interleave) the traffic data and signaling messages. A modulator (Mod) 214 may further process (e.g., symbol map and modulate) the encoded traffic data and signaling messages and provide output samples. A transmitter (TMTR) 222 may condition (e.g., convert to analog, filter, amplify, and frequency upconvert) the output samples and generate an uplink signal, which may be transmitted via an antenna 224 to eNB 122.

On the downlink, antenna 224 may receive downlink signals transmitted by eNB 122 and/or other eNBs/base stations. A receiver (RCVR) 226 may condition (e.g., filter, amplify, frequency downconvert, and digitize) the received signal from antenna 224 and provide input samples. A demodulator (Demod) 216 may process (e.g., demodulate) the input samples and provide symbol estimates. A decoder 218 may process (e.g., deinterleave and decode) the symbol estimates and provide decoded data and signaling messages sent to UE 110. Encoder 212, modulator 214, demodulator 216, and decoder 218 may be implemented by a modem processor 210. These units may perform processing in accordance with the RAT (e.g., LTE, 1xRTT, etc.) used by the wireless network with which UE 110 is in communication.

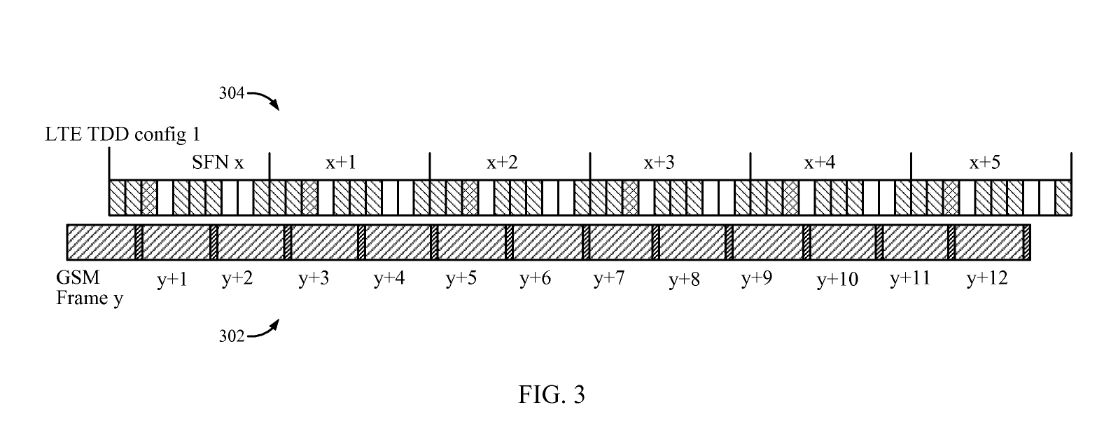

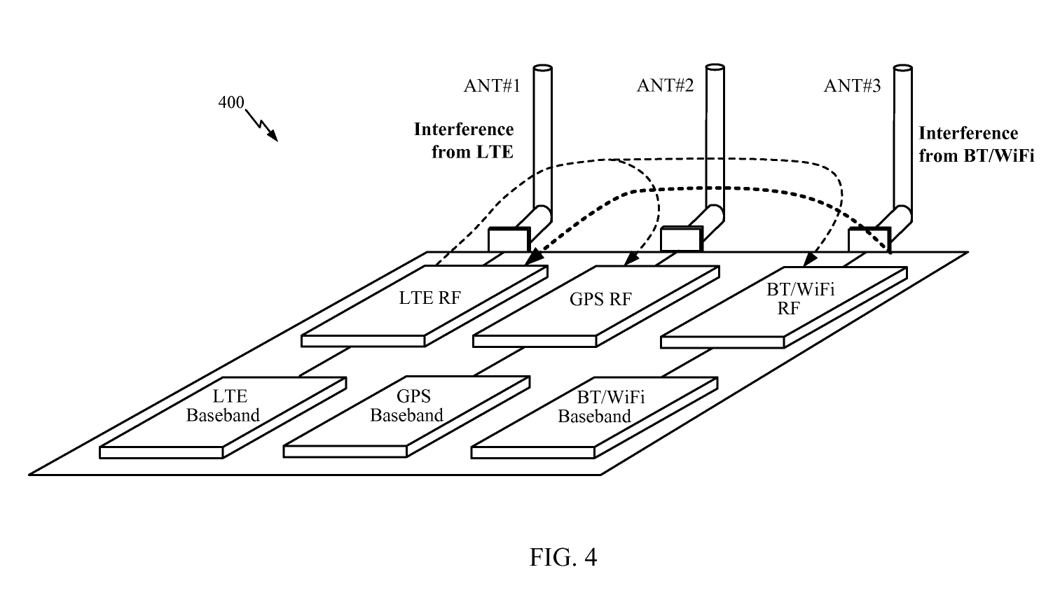

A controller/processor 230 may direct the operation at UE 110. Controller/processor 230 may also perform or direct other processes for the techniques described herein. Controller/processor 230 may also perform or direct the processing by UE 110 in FIGS. 3 and 4. Memory 232 may store program codes and data for UE 110. Memory 232 may also store a priority list and configuration information.

At eNB 122, a transmitter/receiver 238 may support radio communication with UE 110 and other UEs. A controller/processor 240 may perform various functions for communication with the UEs. On the uplink, the uplink signal from UE 110 may be received via an antenna 236, conditioned by receiver 238, and further processed by controller/processor 240 to recover the traffic data and signaling messages sent by UE 110. On the downlink, traffic data and signaling messages may be processed by controller/processor 240 and conditioned by transmitter 238 to generate a downlink signal, which may be transmitted via antenna 236 to UE 110 and other UEs. Controller/processor 240 may also perform or direct other processes for the techniques described herein. Controller/processor 240 may also perform or direct the processing by eNB 122 in FIGS. 3 and 4. Memory 242 may store program codes and data for the base station. A communication (Comm) unit 244 may support communication with MME 126 and/or other network entities.

At MME 126, a controller/processor 250 may perform various functions to support communication services for UEs. Controller/processor 250 may also perform or direct the processing by MME 126 in FIGS. 3 and 4. Memory 252 may store program codes and data for MME 126. A communication unit 254 may support communication with other network entities.

FIG. 2 shows a block diagram of a design of UE 110, eNB 122, and MME 126 in FIG. 1. At UE 110, an encoder 212 may receive traffic data and signaling messages to be sent on the uplink. Encoder 212 may process (e.g., format, encode, and interleave) the traffic data and signaling messages. A modulator (Mod) 214 may further process (e.g., symbol map and modulate) the encoded traffic data and signaling messages and provide output samples. A transmitter (TMTR) 222 may condition (e.g., convert to analog, filter, amplify, and frequency upconvert) the output samples and generate an uplink signal, which may be transmitted via an antenna 224 to eNB 122.

On the downlink, antenna 224 may receive downlink signals transmitted by eNB 122 and/or other eNBs/base stations. A receiver (RCVR) 226 may condition (e.g., filter, amplify, frequency downconvert, and digitize) the received signal from antenna 224 and provide input samples. A demodulator (Demod) 216 may process (e.g., demodulate) the input samples and provide symbol estimates. A decoder 218 may process (e.g., deinterleave and decode) the symbol estimates and provide decoded data and signaling messages sent to UE 110. Encoder 212, modulator 214, demodulator 216, and decoder 218 may be implemented by a modem processor 210, for example. These units may perform processing in accordance with the RAT (e.g., LTE, GSM, 1xRTT, etc.) used by the wireless network with which UE 110 is in communication.

According to aspects, as will be described in more details herein, the UE 110 may support communications with multiple RATs (e.g., concurrent RATs) (CRAT). The CRAT UE may share uplink transmissions between two RATs, for example, in terms of TDM. The CRAT UE may support dual receiving of downlink transmissions.

A controller/processor 230 may direct the operation at UE 110. Controller/processor 230 may also perform or direct other processes for the techniques described herein. In aspects, one or more of any of the components of the UE 110 may be employed to perform example operations 400, 500, 700 and/or other processes for the techniques described herein. Memory 232 may store program codes and data for UE 110. Memory 232 may also store a priority list and configuration information.

At eNB 122, a transmitter/receiver 238 may support radio communication with UE 110 and/or other UEs. A controller/processor 240 may perform various functions for communication with the UEs. On the uplink, the uplink signal from UE 110 may be received via an antenna 236, conditioned by receiver 238, and further processed by controller/processor 240 to recover the traffic data and signaling messages sent by UE 110. On the downlink, traffic data and signaling messages may be processed by controller/processor 240 and conditioned by transmitter 238 to generate a downlink signal, which may be transmitted via antenna 236 to UE 110 and/or other UEs. Controller/processor 240 may also perform or direct other processes for the techniques described herein. In aspects, one or more of any of the components of the UE 110 may be employed to perform example operations 600, 800 and/or other processes for the techniques described herein. However, any component shown in FIG. 1 (e.g., base station 132) may perform example operations 600, 800 and/or other processes for the techniques described herein. Memory 242 may store program codes and data for the base station. A communication (Comm) unit 244 may support communication with MME 126 and/or other network entities.

At MME 126, a controller/processor 250 may perform various functions to support communication services for UEs. Memory 252 may store program codes and data for MME 126. A communication unit 254 may support communication with other network entities.

FIG. 2 shows simplified designs of UE 110, eNB 122, and MME 126. In general, each entity may include any number of transmitters, receivers, processors, controllers, memories, communication units, etc. Other network entities may also be implemented in similar manner.

For example, UE 110 of FIG. 2 comprises a single TMTR 222 and a single RCVR 226. According to aspects, UE 110 may comprise a single TMTR and a dual RCVR, and therefore may support CRAT. For example, UE 110 may share uplink transmissions between two RATs and may support dual downlink receiving. According to aspects, the UE may support CRAT with LTE and GMS or CDMA2000 1xRTT.

One challenge with utilizing a single transmitter for concurrent communications is that, at times, there may be conflicts between scheduled uplink transmissions in both RATs. While the conflict may occur with an uplink transmission, the uplink transmission itself may result from a scheduled downlink transmission. For example, for scheduled LTE downlink transmissions, a UE may need to transmit an ACK in uplink to confirm it received the data. In other words, it is possible that a UE may be scheduled for uplink transmission in both RATs during given a transmission period.

In some cases, Rx with multiple RATs (e.g., concurrent Rx) may also be achieved. For example, two Rx (e.g., two separate receive chains with two separate antennas) may be shared by GSM or CDMA2000 1xRTT, and LTE in a manner similar to Simultaneous Hybrid Dual Receivers (SHDR). When GSM or CDMA2000 1xRTT receiving is not needed, LTE may use two receive chains for multiple input multiple output (MIMO) and diversity. When GSM or CDMA2000 1xRTT receiving is needed, one Rx may be tuned to GSM or CDMA2000 1xRTT, and the remaining Rx may be used for LTE receiving. In some embodiments, since only one receive chain is being used for LTE, the UE may report a fake channel quality indictor (CQI) to avoid eNB scheduling for dual layer transmission.

However, UE 110 shown in FIG. 2 comprises a single TMTR 222 and single RCVR 226, and therefore may only communicate with a single RAT at any give time, for example, LTE network 102 or GSM network 104 shown in FIG. 1.

### Example UE Transmitter Sharing by GSM and LTE

Simultaneous GSM and LTE (SG-LTE) is a type of high-end technology for a UE as compared to Circuit-Switched Fallback (CSFB) UEs. A SG-LTE UE is registered on a GSM CS network and a LTE packet switched (PS) network in parallel. SG-LTE allows concurrent CS and PS communications. Concurrent CS and PS communication is not supported on CSFB to GSM except where both UE and the GSM cell support data transfer mode (DTM).

However, the cost of SG-LTE is relatively high because it requires two RF chains (i.e., dual receiver (Rx) and dual transmitter (Tx)) and associated filters to isolate the two RF chains. Another drawback of SG-LTE is high power consumption due to dual camping on GSM and LTE.

CSFB and Single Radio LTE (SR-LTE) are alternative, relatively low cost solutions for a UE with a single Rx/Tx to support both LTE and GSM. However, CSFB to GSM and SR-LTE do not support concurrent CS and high performance PS. CSFB to GSM techniques interrupt PS transmissions, even if the user rejects the incoming CS call and suspends PS during the CS call.

One challenge with utilizing a single transmitter (Tx) solution for concurrent communications is that, at times, there may be conflicts between scheduled uplink transmissions in both radio access technologies (RATs). While the conflict may occur with an UL transmission, the UL transmission itself may result from a scheduled DL transmission. For example, for scheduled LTE DL transmissions, a UE sends ACK in uplink to confirm it received the DL data. In other words, as illustrated in FIG. 3, it is possible a UE may be scheduled for uplink transmission in both RATs during given transmission periods (e.g., time slot for GSM or subframe for LTE as shown in FIG. 3) sharing the single Tx in terms of TDM.

GSM transmission may occur regularly in one fixed timeslot of a radio frame (e.g., a UE may transmit on the uplink for 0.577 μs in every 4.615 frame). For 1xCDMA, the transmission may be continuous. LTE transmission may be flexible in time, per scheduling. GSM and LTE transmissions may collide when scheduled to occur at the same time. One solution to enable GSM and LTE to share a transmitter is generally referred to as “autonomous denial.” By autonomous denial, a UE decides to deny or skip an LTE UL transmission when the transmission conflicts with a GSM UL transmission.

In some cases, concurrent Rx may also be achieved. For example, two Rx (e.g., two separate receive chains with two separate antennas) may be shared by GSM and LTE in a manner similar to Simultaneous Hybrid Dual Receivers (SHDR). When GSM receiving is not needed, LTE may use two Rx for multiple input multiple output (MIMO) and diversity. When GSM receiving is needed, one Rx may be tuned to GSM and the remaining Rx may be used for LTE receiving. In some embodiments, since only one receive chain is being used for LTE, the UE may report fake rank indictor/precoding matrix indictor/channel quality indictor (RI/PMI/CQI) to avoid eNB scheduling for dual layer transmission.

As noted above, GSM and LTE may share a transmitter by autonomous denial by skipping UL transmissions that conflict with GSM UL transmissions. Autonomous denial may lead to UL transmission missing on Physical Uplink Control Channel (PUCCH), Physical Uplink Shared Channel (PUSCH), Physical Random Access Channel (PRACH), Sounding Reference Signal (SRS), and Demodulated RS (DM-RS).

In the event that UL transmission is missing on PUCCH, there may be missing SR (format 1), missing ACK/NACK (format 1a/1b), or missing CQI (format 2/2a/2b). If SR is missed, the UE will retransmit SR in the next SR opportunity. If NACK is missed, the eNB will retransmit with no waste. If ACK is missed, the eNB will retransmit wasting one DL transmission. Also, the ACK missing target probability is 1e-2 and collision will increase the probability to:

0.342+0.658*0.01=0.35

Missing ACK may impact DL Outer Loop Link Adaptation (OLLA) due to increasing of eNB perceived block error rate (BLER). Missing ACK may also cause PDCCH to use high aggregation level to improve DL control signaling reliability, which in turn decreases DL capacity.

For missing UL transmission on CQI, the UE will re-transmit CQI, which causes CQI update delay. There is limited impact on DL throughput if the UE is not in high-speed mobility. PUCCH power control may be impacted if the power control is driven by CQI erasure ratio.

For missing UL transmissions on PUSCH, the eNB will regard data as discontinuous transmission (DTX) and the UE will retransmit data in the next round trip time (RTT). Assuming a BLER target of 10%, the BLER increases to:

0.342+0.658*0.1=0.4

after considering PUSCH data missing. Collision may impact PUSCH power control and OLLA. CQI/PMI/RI update delay causes offset on MCS level on downlink. The eNB may regard UE with collision as a transmission failure. Buffer Status Report (BSR) update delay causes offset on bandwidth allocation on UL. Power Headroom Report (PHR) update delay causes offset on modulation and coding schemes (MCS) level on UL. The eNB can request to retransmit PHR if the eNB finds PHR is outdated, or eNB can leave room for PHR. Missing ACK/NACK on PUCCH is the same as missing ACK/NACK on PUSCH.

For missing UL transmissions on PRACH, Initial Access, RRC Connection Re-establishment, handover, and Prior to Downlink Transmission may be missing. For missing initial access, RRC Connection Re-establishment, and/or Prior to Downlink Transmission (e.g., UL Synchronization, PUCCH resource allocation), the UE can retransmit. For handover, the UE can retransmit, but there is increased delay.

In some cases, missing SRS and/or DM-RS may affect timing estimation. Autonomous denial may impact performance: UL probability: 34.2%; DL throughput loss: 30.92%; and UL throughput loss: 32.77%. It may be noted that impact of ILLA and Open Loop Power Control (OLPC) are not considered in the above results and that the real performance impact may be larger. For OLLA in DL, the eNB may downgrade DL MCS very low due to high BLER from missing ACK. For OLPC in UL, the eNB may tune up the power of the UE due to high BLER from missing PUSCH. To avoid the impact of OLLA and OLPC, the UE may report fake CQI to avoid or mitigate MCS downgrade, adjust sounding power to alleviate UL MSC downgrade, or selectively ignore OLPC if triggered by autonomous denial.

A high autonomous denial rate may trigger the eNB to handle the UE specially by de-prioritizing the UE in scheduling or disconnecting the UE. Concurrent GSM CS and LTE PS may be supported by autonomous denial based Tx sharing only a best effort basis.

Autonomous denial provides one approach to achieve concurrent GSM and LTE as SG-LTE does, without network or standards changes. However, autonomous denial has the drawbacks of downgraded UL and DL throughput.

Techniques and apparatus are presented herein for achieving SG-LTE like GSM and LTE concurrency utilizing only a single radio frequency (RF) chain.

According to certain aspects, higher autonomous denial rate is allowed. In aspects, the LTE network may be upgraded to tolerate a high denial rate and high BLER. Alternatively, denial rate negotiation may be performed. The UE may request autonomous denial rate, for example, in a RRC Connection Setup Complete message. The eNB may then reply with a negotiated denial rate, for example, in the RRC Connection Reconfiguration message. The UE may then follow the negotiated denial rate in performing autonomous denial.

According to certain aspects, smart scheduling by the eNB per assistance information from the UE may be used to enable Tx sharing. The UE may report assistance information to the eNB. For Time Division Multiplexing (TDM) based InDeviceCoexistence (IDC), the UE may request the eNB to avoid the IDC problem (i.e., a collision) by TDM in terms of either discontinuous reception (DRX) assistance information or subframe patterns information.

According to certain aspects, the DRX-CycleLength may be extended to include sf60:
drx-CycleLength-r11 ENUMERATED {sf40, sf60, sf64, sf80, sf128, sf160, sf256, spare2, spare1}
   In the example scenario shown in FIG. 3, collision occurs on x+3, x+4, x+5. These three radio frames may be DRX′d by:

Drx-CycleLength=sf60

Drx-Offset=30

In aspects, as another example of assistance information, a UE may also directly report the GSM channel and timing information to eNB.

FIG. 4 illustrates an example UE 400 supporting multiple interfering RATs (e.g., LTE, WiFi, GPS, Bluetooth), in accordance with certain aspects of the present disclosure. A UE may support multiple RATs which may interfere as shown in FIG. 4.

Mutual interference increases the UE cost and downgrades the performance. IDC procedures may mitigate the interference by TDM and or Frequency Division Multiplexing (FDM).

Aspects of the present disclosure may help enable simultaneous communications by a UE with a single transceiver. As will be described in greater detail below, the UE may negotiate an autonomous denial rate, allowing the UE to deny or skip some UL transmissions in one of the RATs. According to certain aspects, additionally or alternatively, a UE may provide assistance information that a base station (e.g., an eNB) may use to try to avoid scheduling UL transmissions on its RAT that would conflict with UL transmissions on the other RAT. In some cases, a base station may gather information about the other RAT and use this information to try to avoid scheduling UL transmissions on its RAT that would conflict with UL transmissions on the other RAT.

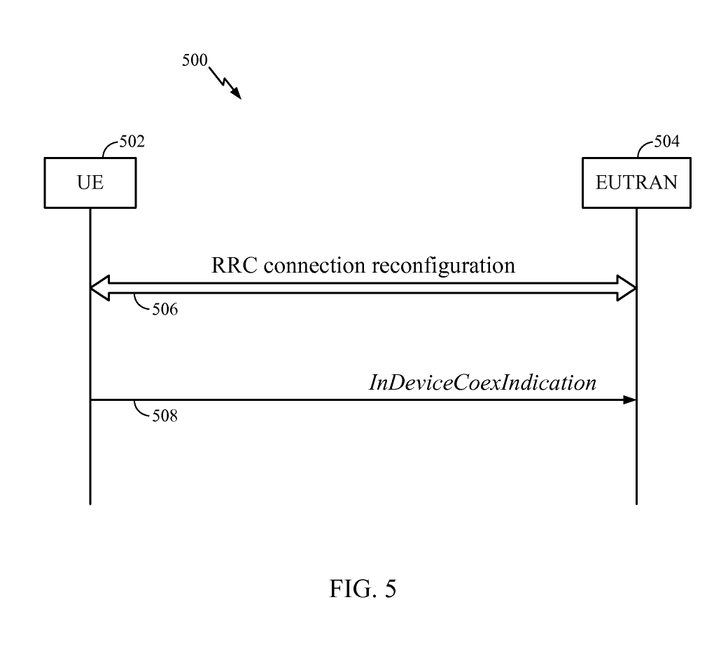

FIG. 5 illustrates an example IDC procedure 500, in accordance with certain aspects of the present disclosure. As shown in FIG. 5, a UE 502 may provide an IDC indication 508 to the eNB 504. In aspects, the IDC indication 508, may inform E-UTRAN 504 about IDC problems which may not be solved by the UE 502 and provide information that may assist E-UTRAN 504 in resolving these problems.

According to certain aspects, the IDC indication 508 for FDM, the UE may report a list of LTE carrier frequencies that have IDC problems. In some embodiments, in TDM, the UE may request the eNB to avoid IDC problems by TDM in terms of DRX assistance information or subframe patterns information.

In aspects, DRX assistance information may include UE requested E-UTRAN DRX parameters: DRX cycle length, DRX offset, and DRX active time. Subframe pattern information includes: a list of up to eight subframe patterns,

| | |
|---|---|
| subframePatternFDD-r11 | BIT STRING (SIZE (40)) |
| subframePatternTDD-r11 | Choice of |
| subframeConfig0-r11 | BIT STRING (SIZE (70)) |
| subframeConfig1-5-r11 | BIT STRING (SIZE (10)) |
| subframeConfig6-r11 | BIT STRING (SIZE (60)) |

According to certain aspects, a bit in pattern set to 0 means the eNB should not schedule transmission at that subframe.

GSM and LTE collision pattern repeats every 60 ms (GSM Radio Frame length: 4.615 ms=60/13 ms). In aspects, the subframe pattern Bitmap may be extended to 60 bits or multiple times of 60 bits.

| | |
|---|---|
| subframePatternFDD-r11 | BIT STRING (SIZE (120)) |
| subframePatternTDD-r11 | Choice of |
| subframeConfig0-r11 | BIT STRING (SIZE (70)) |
| subframeConfig1-5-r11 | BIT STRING (SIZE (60)) |
| subframeConfig6-r11 | BIT STRING (SIZE (60)) |

With the subframe pattern information, the eNB may avoid scheduling transmission in the conflicting subframes. In some embodiments, with the conflicting subframe information, the eNB may freeze power/rate control loops at the conflicting subframes.

According to certain aspects, RAN Information Management (RIM) (e.g., exchanged over a backhaul connection between base stations of different RATs) may be used to coordinate between base station controller (BSC) and eNB, for example, GSM system information may be transmitted between BSC and eNB using RIM. RIM may be extended to include channel information of the UE in GSM dedicated mode. In some embodiments, the BSC may transmit UE channel information per a request from the eNB. The eNB may detect multiple DTX of the UE and request BSC(s) of the overlapping GSM network to check whether the UE is in parallel GSM communication.

According to certain aspects, a base station may gather information. For example, an eNB may detect DTX. The eNB may detect the subframe pattern information per DTX of the UE in UL. The eNB may avoid transmitting in the predicted DTX subframes.

In aspects, a single transmitter (Tx) may also be shared in simultaneous voice LTE (SV-LTE, for example, simultaneous cdma2000 and LTE). 1× transmissions may be skipped when LTE transmits. If the skipping rate is too high to ensure 1× voice quality, some LTE transmissions may be skipped. This may permit 1× to transmit continuously in time. Voice may be protected by both EVRC and convolution code. Voice quality is not significantly impacted by skipping some transmissions. The impact to voice quality may be further reduced by OLPC. The impact to LTE for SV-LTE is similar to the impact to LTE for SG-LTE.

SR-LTE, for networks not supporting CSFB, utilizes dual standby and single active Rx, Tx. CSFB utilizes a single standby and single active Rx, Tx. SR-SGLTE supports concurrent CS/PS utilizes dual standby and dual active Rx and single Tx. (DR-)SG-LTE supports current CS/PS and utilizes dual standby and dual active Rx and Tx. DR-CSFB utilizes single standby Tx and dual active Rx and Tx.

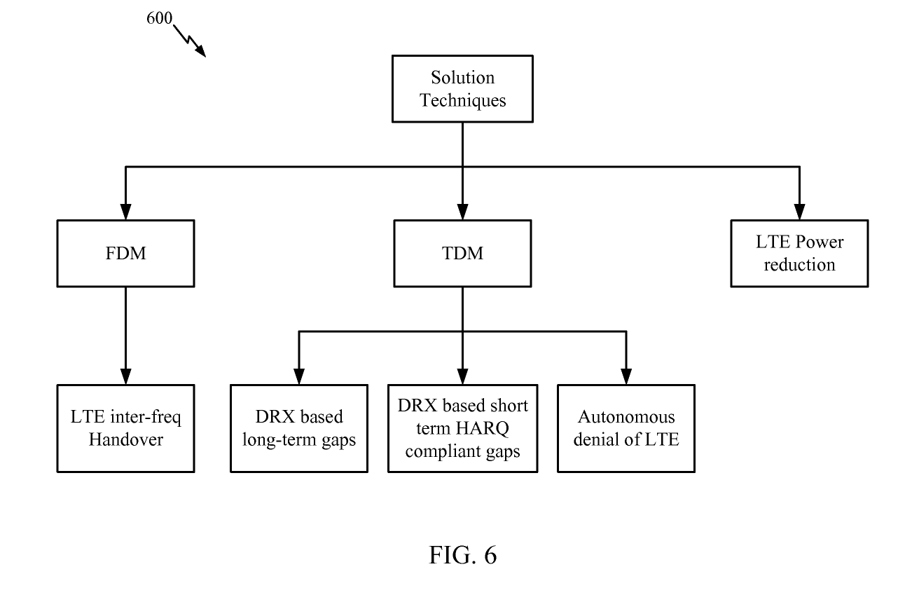

FIG. 6 illustrates a block diagram 600 overview of solution techniques, in accordance with certain aspects of the present disclosure. As shown, solution techniques may include FDM solutions, TDM solutions, and LTE power reduction. FDM solution includes LTE inter-frequency handover and TDM solutions include DRX based long-term gaps, DRX based short term HARQ compliant gaps, and autonomous denial of LTE. FDM/TDM solutions are triggered by a co-existence message from the UE to the eNB and are initiated/confirmed after eNB response.

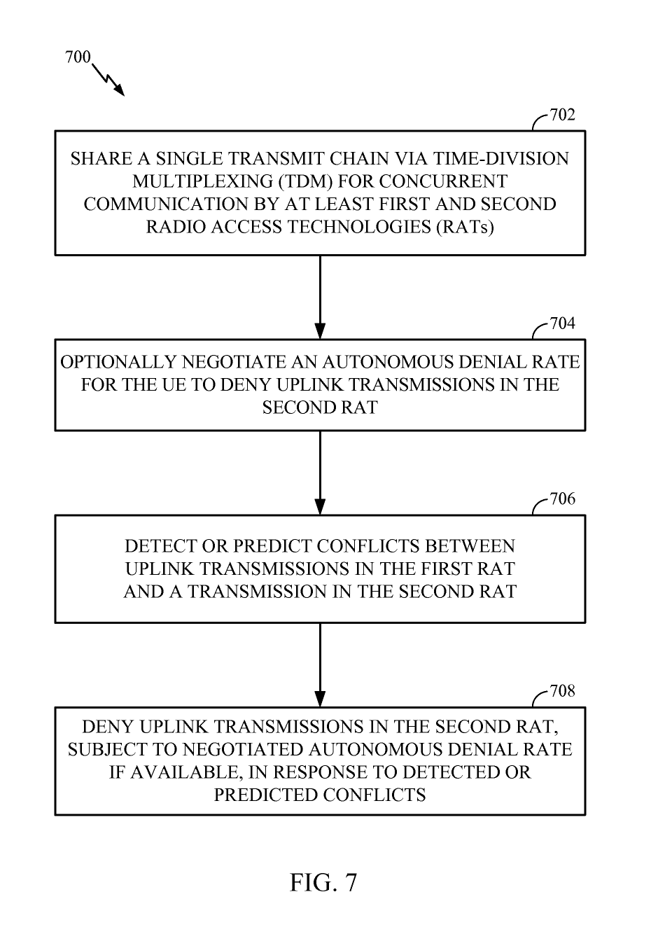

FIG. 7 illustrates example operations 700 for wireless communications, in accordance with certain aspects of the present disclosure. The operations 700 may be performed, for example, by a UE (e.g., UE 110). The operations 700 may begin, at 702, by sharing a single transmit chain via TDM for concurrent communication by at least first and second RATs (e.g., LTE, GSM, CSMA2000 1xRTT).

At 704, the UE optionally negotiates an autonomous denial rate for the UE to deny uplink transmissions in the second RAT. For example, the UE sends a message with a request for an autonomous denial rate during an RRC connection procedure.

At 706, the UE detects or predicts conflicts between uplink transmissions in the first RAT and a transmission in the second RAT.

And at 708, the UE denies uplink transmissions in the second RAT, subject to the negotiated autonomous denial rate if available, in response to detected or predicted conflicts. For example, the UE denies uplink transmissions only if the negotiated denial rate has not been exceeded over a predetermined period.

According to certain aspects, the UE may receive a message with a negotiated autonomous denial rate in response to the request.

According to certain aspects, the UE may send one or more modified reporting parameters to compensate for denying uplink transmissions. In aspects, the UE sends modified rank indication (RI), channel quality indicator (CQI), or Precoding Matrix Indicator (PMI) to avoid multi-layer transmissions from a base station of the second RAT. Alternatively, the UE may send modified CQI to avoid or mitigate an ULMCS downgrade. In aspects, the UE may ignore OLPC if triggered by denying uplink transmissions in the second RAT. The UE may also adjust transmit power of SRS to avoid or mitigate an UL MCS downgrade.

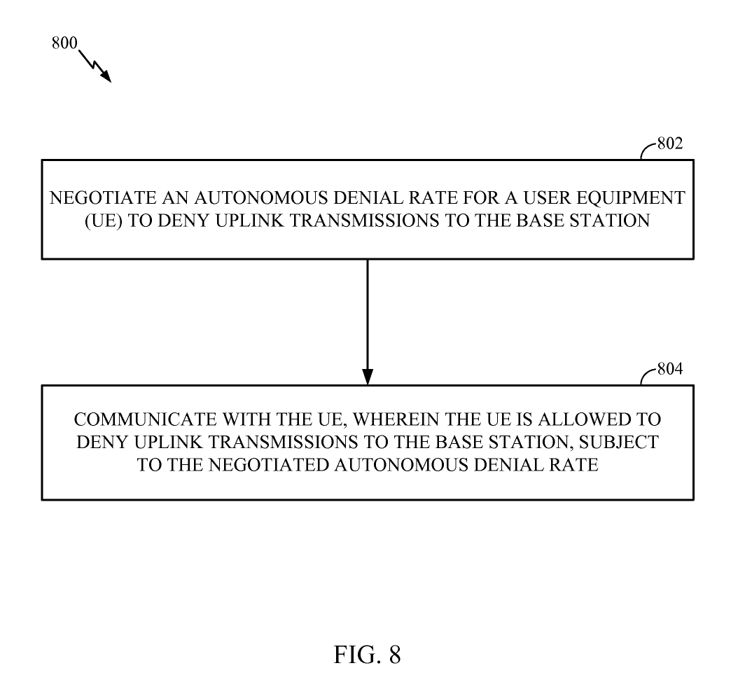

FIG. 8 illustrates example operations 800 for wireless communications, in accordance with certain aspects of the present disclosure. The operations 800 may be performed, for example, by a base station, such as an LTE eNB (e.g., eNB 122). The operations 800 may begin, at 802, by negotiating an autonomous denial rate for a UE to deny uplink transmissions to the base station. For example, the base station may receive a message, from the UE, with a request for an autonomous denial rate during an RRC connection procedure.

And at 804, the base station may communicate with the UE, wherein the UE is allowed to deny uplink transmissions to the base station, subject to the negotiated autonomous denial rate. According to certain aspects, the base station may also transmit, to the UE, a message with a negotiated autonomous denial rate in response to the request.

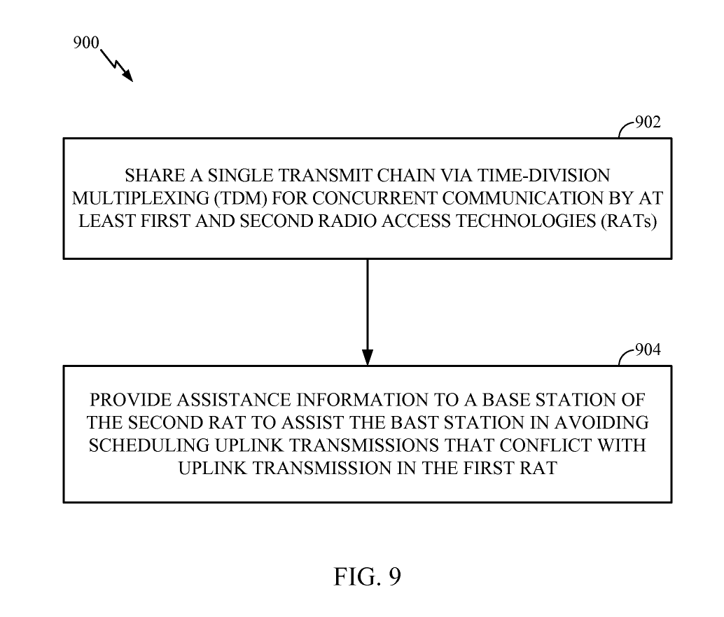

FIG. 9 illustrates example operations 900 for wireless communications, in accordance with certain aspects of the present disclosure. The operations 900 may be performed, for example, by a UE (e.g., UE 110). The operations 900 may begin, at 902, by sharing a single transmit chain via TDM for concurrent communication by at least first and second RATs (e.g., LTE, GSM, CDMA2000 1xRTT).

And at 904, the UE may provide assistance information to a base station of the second RAT to assist the base station in avoiding scheduling uplink transmissions that conflict with uplink transmissions in the first RAT. According to certain aspects, the assistance information may be provided as a pattern of bits, each bit indicating whether or not the base station should schedule an uplink transmission in a corresponding subframe. The length of the pattern may be selected to be equal to or greater than a period with which a pattern in which uplink transmissions in the first and second RAT conflicts repeats. For example, the length may be at least 60 bits for LTE TDD configurations 1-6 (e.g., 120 bits) or at least 420 bits for LTE TDD configuration 0.

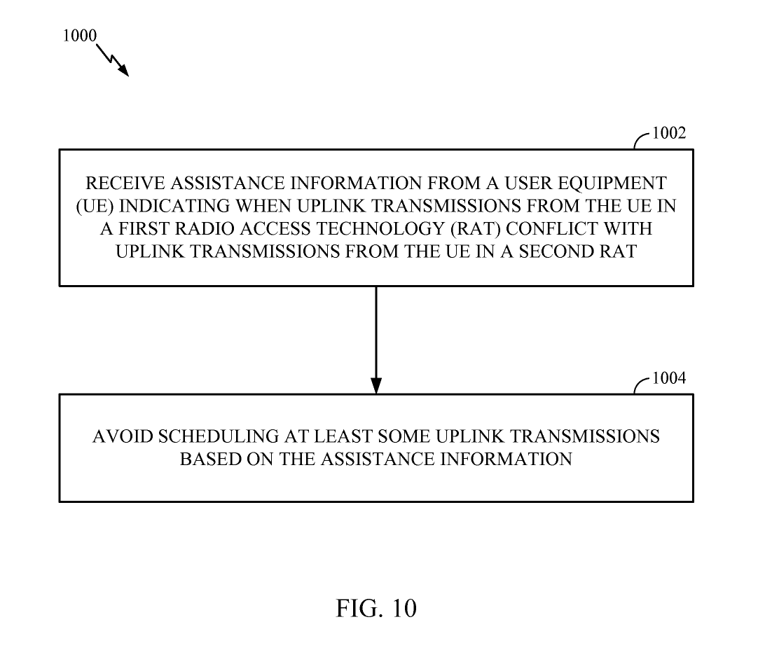

FIG. 10 illustrates example operations 1000 for wireless communications, in accordance with certain aspects of the present disclosure. The operations 1000 may be performed, for example, by a base station, such as an LTE eNB (e.g., eNB122). The operations 1000 may begin at 1002, by receiving assistance information from a UE indicating when uplink transmissions from the UE in a first RAT conflict with uplink transmissions from the UE in a second RAT (e.g., LTE, GSM, CDMA2000 1xRTT). According to certain aspects, the assistance information may be provided as a pattern of bits, each bit indicating whether or not the base station should schedule an uplink transmission in a corresponding subframe. The length of the pattern may be selected to be equal to or greater than a period with which a pattern in which uplink transmissions in the first and second RAT conflicts repeats. For example, the length may be at least 60 bits (e.g., 120 bits) for LTE TDD configurations 1-6 or at least 420 bits for LTE TDD configuration 0.

And at 1004, the base station avoids scheduling at least some uplink transmissions from the UE in the second RAT based on the assistance information. According to certain aspects, the UE may adjust power control or rate control, based on the assistance information.

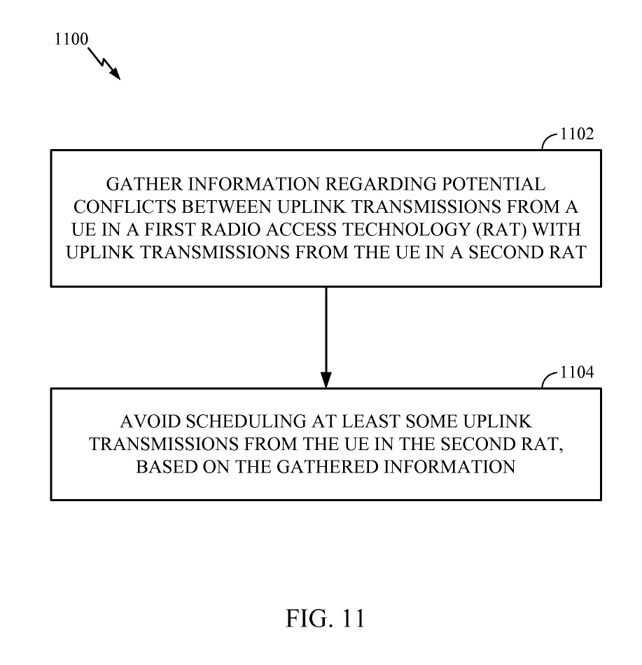

FIG. 11 illustrates example operations 1100 in accordance with certain aspects of the present disclosure. The operations 1100 may be performed, for example, by a base station, such as an LTE eNB (e.g., eNB 122). The operations 1100 may begin, at 1102, by gathering information regarding potential conflicts between uplink transmissions from a UE in a first RAT with uplink transmissions from the UE in a second RAT. For example, the base station may receive information (e.g., channel information of the UE) regarding the first RAT, via backhaul messaging. In aspects, the base station may detect a subframe pattern for DTX of the UE in the uplink of the second RAT.

And at 1104, the base station may avoid scheduling at least some uplink transmissions from the UE in the second RAT, based on the gathered information. For example, the base station may avoid scheduling transmissions in predicted DTX subframes.

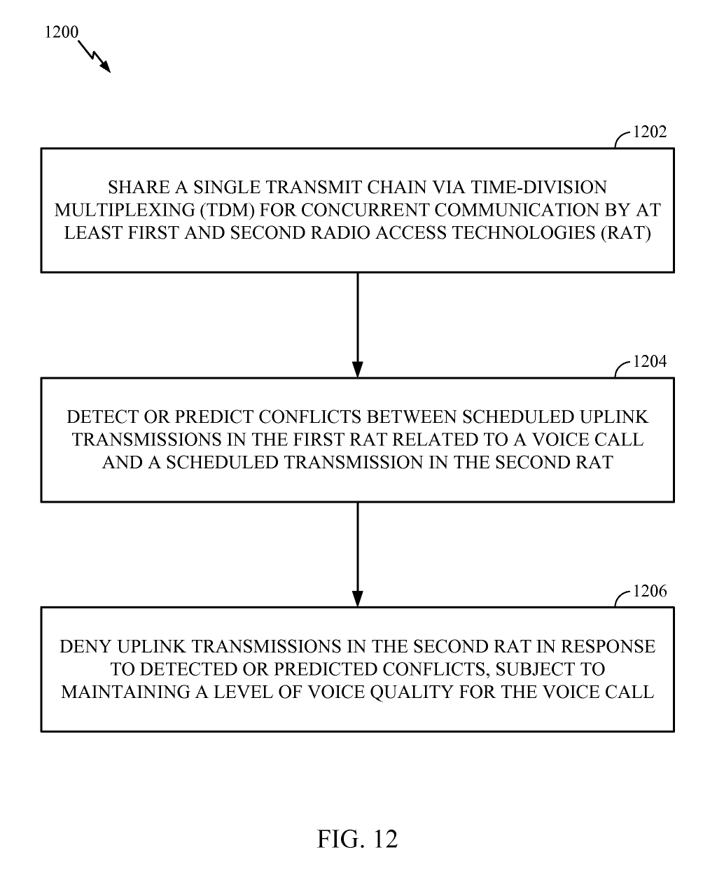

FIG. 12 illustrates example operations 1200 for wireless communications, in accordance with certain aspects of the present disclosure. The operations 1200 may be performed, for example, by a UE (e.g., UE 110). The operations 1200 may begin, at 1202, by sharing a single Tx chain via TDM for concurrent communication by at least first and second RAT (LTE, GSM, CDMA2000 1xRTT).

At 1204, the UE may detect or predicts conflicts between scheduled uplink transmissions in the first RAT related to a voice call and a scheduled transmission in the second RAT.

And at 1206, the UE denied uplink transmissions in the first RAT (e.g., GSM or cdma2000 1x) in response to detected or predicted conflicts, subject to maintaining a level of voice quality for the voice call.

According to certain aspects, the UE may deny uplink transmissions in the second RAT in response to detected or predicted conflicts, if denying uplink transmission in the first RAT would not allow ensure the level of voice quality for the voice call can be maintained. The UE may adjust power control in an effort to compensate for a reduction in a level of voice quality caused by denying uplink transmissions in the first RAT.

Several aspects of a telecommunications system has been presented with reference to a GSM and LTE system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communications by a user equipment (UE), comprising:
sharing a single transmit chain via time-division multiplexing (TDM) for concurrent communication by at least first and second radio access technologies (RAT);
negotiating an autonomous denial rate for the UE to deny uplink transmissions in the second RAT;
detecting or predicting conflicts between uplink transmissions in the first RAT and a transmission in the second RAT; and
denying uplink transmissions in the second RAT, subject to the negotiated autonomous denial rate, in response to detected or predicted conflicts.

2. The method of claim 1, wherein the second RAT comprises long-term evolution (LTE).

3. The method of claim 2, wherein the first RAT comprises Global Systems for Mobile Communications (GSM) or CDMA2000 1xRTT.

4. The method of claim 1, wherein denying uplink transmissions subject to the negotiated autonomous denial rate comprises denying uplink transmissions only if the negotiated denial rate has not been exceeded over a predetermined period.

5. The method of claim 1, wherein negotiating an autonomous denial rate comprises sending a message with a request for an autonomous denial rate during an RRC connection procedure.

6. The method of claim 5, further comprising receiving a message with a negotiated autonomous denial rate in response to the request.

7. The method of claim 1, further comprising sending one or more modified reporting parameters to compensate for denying uplink transmissions.

8. The method of claim 7, wherein one or more modified reporting parameters comprises at least one of a modified rank indication (RI), channel quality indicator (CQI), or Precoding Matrix Indicator (PMI) to avoid multi-layer transmissions from a base station of the second RAT.

9. The method of claim 7, wherein one or more modified reporting parameters comprises a modified channel quality indicator (CQI) to avoid or mitigate an uplink (UL) modulation and coding scheme (MCS) downgrade.

10. The method of claim 1, further comprising ignoring open loop power control if triggered by denying uplink transmissions in the second RAT.

11. The method of claim 1, further comprising adjusting transmit power of sounding reference signals to avoid or mitigate an uplink (UL) modulation and coding scheme (MCS) downgrade.

12. A method for wireless communications by a base station, comprising:
negotiating an autonomous denial rate for a user equipment (UE) to deny uplink transmissions to the base station; and
communicating with the UE, wherein the UE is allowed to deny uplink transmissions to the base station, subject to the negotiated autonomous denial rate.

13. The method of claim 12, wherein negotiating an autonomous denial rate comprises receiving a message, from the UE, with a request for an autonomous denial rate during an RRC connection procedure.

14. The method of claim 13, further comprising transmitting, to the UE, a message with a negotiated autonomous denial rate in response to the request.

15. A method for wireless communications by a user equipment (UE), comprising:
sharing a single transmit chain via time-division multiplexing (TDM) for concurrent communication by at least first and second radio access technologies (RAT); and
providing assistance information to a base station of the second RAT to assist the base station in avoiding scheduling uplink transmissions that conflict with uplink transmission in the first RAT.

16. The method of claim 15, wherein the second RAT comprises long-term evolution (LTE).

17. The method of claim 16, wherein the first RAT comprises Global System for Mobile Communications (GSM) or CDMA2000 1xRTT.

18. The method of claim 15, wherein the assistance information is provided as a pattern of bits, each bit indicating whether or not the base station should schedule an uplink transmission in a corresponding subframe.

19. The method of claim 18, wherein:
a length of the pattern is selected to be equal to or greater than a period with which a pattern in which uplink transmissions in the first and second RAT conflicts repeats.

20. The method of claim 18, wherein:
the first RAT comprises GSM and the second RAT comprises LTE.

21. The method of claim 19, wherein the length of the pattern comprises:
at least 60 bits for LTE Time Division Duplexing (TDD) configurations 1-6; or at least 420 bits for LTE TDD configuration 0.

22. The method of claim 18, wherein:
the second RAT comprises LTE Frequency Division Duplexing (FDD); and
the length of the pattern comprises at least 120 bits.

23. A method for wireless communications by a base station, comprising:
receiving assistance information from a user equipment (UE) indicating when uplink transmissions from the UE in a first radio access technology (RAT) conflict with uplink transmissions from the UE in a second RAT; and
avoiding scheduling at least some uplink transmissions based on the assistance information.

24. The method of claim 23, wherein the second RAT comprises long-term evolution (LTE).

25. The method of claim 24, wherein the first RAT comprises Global Systems for Mobile Communications (GSM) or CDMA2000 1xRTT.

26. The method of claim 23, wherein the assistance information is provided as a pattern of bits, each bit indicating whether or not the base station should schedule an uplink transmission in a corresponding subframe.

27. The method of claim 26, wherein:
a length of the pattern is selected to be equal to or greater than a period with which a pattern in which uplink transmissions in the first and second RAT conflicts repeats.

28. The method of claim 27, wherein:
the first RAT comprises GSM and the second RAT comprises LTE.

29. The method of claim 28, wherein the length of the pattern comprises:
at least 60 bits for LTE TDD configurations 1-6; or
at least 420 bits for LTE TDD configuration 0.

30. The method of claim 27, wherein:
the second RAT comprises LTE FDD; and
the length of the pattern comprises at least 120 bits.

31. The method of claim 23, further comprising adjusting at least one of power control or rate control, based on the assistance information.

32. A method for wireless communications by a base station, comprising:
gathering information regarding potential conflicts between uplink transmissions from a UE in a first radio access technology (RAT) with uplink transmissions from the UE in a second RAT; and
avoiding scheduling at least some uplink transmissions from the UE in the second RAT, based on the gathered information.

33. The method of claim 32, wherein gathering the information comprises:
receiving information regarding the first RAT, via backhaul messaging.

34. The method of claim 33, wherein the information regarding the first RAT comprises channel information of the UE in the first RAT.

35. The method of claim 32, wherein gathering information comprises detecting a subframe pattern for discontinuous transmission (DTX) of the UE in the uplink of the second RAT.

36. The method of claim 35, wherein avoiding scheduling at least some uplink transmissions from the UE in the second RAT, based on the gathered information comprise avoiding scheduling transmissions in predicted DTX subframes.

37. A method for wireless communications by a user equipment (UE), comprising:
sharing a single transmit chain via time-division multiplexing (TDM) for concurrent communication by at least first and second radio access technologies (RAT);
detecting or predicting conflicts between scheduled uplink transmissions in the first RAT related to a voice call and a scheduled transmission in the second RAT; and
denying uplink transmissions in the first RAT in response to detected or predicted conflicts, subject to maintaining a level of voice quality for the voice call.

38. The method of claim 37, wherein the second RAT comprises long-term evolution (LTE).

39. The method of claim 38, wherein the first RAT comprises GSM or cdma2000 1xRTT.

40. The method of claim 37, further comprising denying uplink transmissions in the second RAT in response to detected or predicted conflicts, if denying uplink transmission in the first RAT would not allow ensure the level of voice quality for the voice call can be maintained.

41. The method of claim 37, further comprising adjusting power control in an effort to compensate for a reduction in a level of voice quality caused by denying uplink transmissions in the first RAT.

42. An apparatus for wireless communications by a user equipment (UE), comprising:
means for sharing a single transmit chain via time-division multiplexing (TDM) for concurrent communication by at least the first and second radio access technologies (RAT);
means for negotiating an autonomous denial rate for the UE to deny uplink transmissions in the second RAT;
means for detecting or predicting conflicts between uplink transmissions in the first RAT and a transmission in the second RAT; and
means for denying uplink transmissions in the second RAT, subject to the negotiated autonomous denial rate, in response to detected or predicted conflicts.

43. An apparatus for wireless communications by a user equipment (UE), comprising:
at least one processor configured to:
share a single transmit chain via time-division multiplexing (TDM) for concurrent communication by at least first and second radio access technologies (RAT);
negotiate an autonomous denial rate for the UE to deny uplink transmissions in the second RAT;
detect or predict conflicts between uplink transmissions in the first RAT and a transmission in the second RAT; and
deny uplink transmissions in the second RAT, subject to the negotiated autonomous denial rate, in response to detected or predicted conflicts; and
a memory coupled with the at least one processor.

44. A computer program product for wireless communications by a user equipment (UE) comprising a computer readable medium having instructions stored thereon, the instructions executable by one or more processors for:
sharing a single transmit chain via time-division multiplexing (TDM) for concurrent communication by at least first and second radio access technologies (RAT);
negotiating an autonomous denial rate for the UE to deny uplink transmissions in the second RAT;
detecting or predicting conflicts between uplink transmissions in the first RAT and a transmission in the second RAT; and
denying uplink transmissions in the second RAT, subject to the negotiated autonomous denial rate, in response to detected or predicted conflicts.

45. An apparatus for wireless communications by a base station, comprising:
means for negotiating an autonomous denial rate for a user equipment (UE) to deny uplink transmissions to the base station; and
means for communicating with the UE, wherein the UE is allowed to deny uplink transmissions to the base station, subject to the negotiated autonomous denial rate

46. An apparatus for wireless communications by a base station, comprising:
at least one processor configured to:
negotiate an autonomous denial rate for a user equipment (UE) to deny uplink transmissions to the base station; and
communicate with the UE, wherein the UE is allowed to deny uplink transmissions to the base station, subject to the negotiated autonomous denial rate; and
a memory coupled with the at least one processor.

47. A computer program product for wireless communications by a base station comprising a computer readable medium having instructions stored thereon, the instructions executable by one or more processors for:
negotiating an autonomous denial rate for a user equipment (UE) to deny uplink transmissions to the base station; and
communicating with the UE, wherein the UE is allowed to deny uplink transmissions to the base station, subject to the negotiated autonomous denial rate

48. An apparatus for wireless communications by a user equipment (UE), comprising:
means for sharing a single transmit chain via time-division multiplexing (TDM) for concurrent communication by at least first and second radio access technologies (RAT); and
means for providing assistance information to a base station of the second RAT to assist the base station in avoiding scheduling uplink transmissions that conflict with uplink transmission in the first RAT.

49. An apparatus for wireless communications by a user equipment (UE), comprising:
at least one processor configured to:
share a single transmit chain via time-division multiplexing (TDM) for concurrent communication by at least first and second radio access technologies (RAT); and
provide assistance information to a base station of the second RAT to assist the base station in avoiding scheduling uplink transmissions that conflict with uplink transmission in the first RAT; and
a memory coupled with the at least one processor.

50. A computer program product for wireless communications by a user equipment (UE) comprising a computer readable medium having instructions stored thereon, the instructions executable by one or more processors for:
sharing a single transmit chain via time-division multiplexing (TDM) for concurrent communication by at least first and second radio access technologies (RAT); and
providing assistance information to a base station of the second RAT to assist the base station in avoiding scheduling uplink transmissions that conflict with uplink transmission in the first RAT.

51. An apparatus for wireless communications by a base station, comprising:
means for receiving assistance information from a user equipment (UE) indicating when uplink transmissions from the UE in a first radio access technology (RAT) conflict with uplink transmissions from the UE in a second RAT; and
means for avoiding scheduling at least some uplink transmissions based on the assistance information.

52. An apparatus for wireless communications by a base station, comprising:
at least one processor configured to:
receive assistance information from a user equipment (UE) indicating when uplink transmissions from the UE in a first radio access technology (RAT) conflict with uplink transmissions from the UE in a second RAT; and
avoid scheduling at least some uplink transmissions based on the assistance information; and
a memory coupled with the at least one processor.

53. A computer program product for wireless communications by a base station comprising a computer readable medium having instructions stored thereon, the instructions executable by one or more processors for:
receiving assistance information from a user equipment (UE) indicating when uplink transmissions from the UE in a first radio access technology (RAT) conflict with uplink transmissions from the UE in a second RAT; and
avoiding scheduling at least some uplink transmissions based on the assistance information.

54. An apparatus for wireless communications by a base station, comprising:
means for gathering information regarding potential conflicts between uplink transmissions from a UE in a first radio access technology (RAT) with uplink transmissions from the UE in a second RAT; and
means for avoiding scheduling at least some uplink transmissions from the UE in the second RAT, based on the gathered information.

55. An apparatus for wireless communications by a base station, comprising:
at least one processor configured to:
gather information regarding potential conflicts between uplink transmissions from a UE in a first radio access technology (RAT) with uplink transmissions from the UE in a second RAT; and
avoid scheduling at least some uplink transmissions from the UE in the second RAT, based on the gathered information; and
a memory coupled with the at least one processor.

56. A computer program product for wireless communications by a base station comprising a computer readable medium having instructions stored thereon, the instructions executable by one or more processors for:
gathering information regarding potential conflicts between uplink transmissions from a UE in a first radio access technology (RAT) with uplink transmissions from the UE in a second RAT; and
avoiding scheduling at least some uplink transmissions from the UE in the second RAT, based on the gathered information.

57. An apparatus for wireless communications by a user equipment (UE), comprising:
means for sharing a single transmit chain via time-division multiplexing (TDM) for concurrent communication by at least first and second radio access technologies (RAT);
means for detecting or predicting conflicts between scheduled uplink transmissions in the first RAT related to a voice call and a scheduled transmission in the second RAT; and
means for denying uplink transmissions in the first RAT in response to detected or predicted conflicts, subject to maintaining a level of voice quality for the voice call.

58. An apparatus for wireless communications by a user equipment (UE), comprising:
at least one processor configured to:
share a single transmit chain via time-division multiplexing (TDM) for concurrent communication by at least first and second radio access technologies (RAT);
detect or predict conflicts between scheduled uplink transmissions in the first RAT related to a voice call and a scheduled transmission in the second RAT; and
deny uplink transmissions in the first RAT in response to detected or predicted conflicts, subject to maintaining a level of voice quality for the voice call; and
a memory coupled with the at least one processor.

59. A computer program product for wireless communications by a user equipment (UE) comprising a computer readable medium having instructions stored thereon, the instructions executable by one or more processors for:
sharing a single transmit chain via time-division multiplexing (TDM) for concurrent communication by at least first and second radio access technologies (RAT;
detecting or predicting conflicts between scheduled uplink transmissions in the first RAT related to a voice call and a scheduled transmission in the second RAT; and
denying uplink transmissions in the first RAT in response to detected or predicted conflicts, subject to maintaining a level of voice quality for the voice call.
